(19) United States
(12) Patent Application Publication
(10) Pub. No.: US 2020/0065508 A1
(43) Pub. Date: Feb. 27, 2020

(54) DEVICE AND METHOD TO SHARE IMAGE RECEIVED FROM USER TERMINAL WITH OTHER USER TERMINALS

(71) Applicant: NHN Corporation, Gyeonggi-do (KR)

(72) Inventor: Byung Chan Lee, Gyeonggi-do (KR)

(21) Appl. No.: 16/512,377

(22) Filed: Jul. 16, 2019

(30) Foreign Application Priority Data
Aug. 23, 2018 (KR) 10-2018-0098447

(51) Int. Cl. G06F 21/62; G06F 16/51; H04L 29/06; G06F 16/28

(52) U.S. Cl. CPC G06F 21/6218; G06F 16/284; H04L 63/0861; G06F 16/51

(57) ABSTRACT

An image sharing server includes a communicator and an image sharing device configured to communicate with a user terminal through the communicator. The image sharing device is configured to generate a shared database by receiving mapping information mapping between pieces of first identification data corresponding to a plurality of characters and first client user identifications (IDs) from the user terminal accessing through a main user ID, to acquire pieces of second identification data corresponding to characters of a first image provided from the user terminal, to select a client user ID being mapped to all of the pieces of second identification data among the first client user IDs with reference to the mapping information, and to permit the selected client user ID to access the first image.

### CROSS REFERENCE TO RELATED APPLICATION(S)

This application claims the priority to Korean Patent Application No. 10-2018-0098447, filed on Aug. 23, 2018, which is all hereby incorporated by reference in its entirety.

### BACKGROUND

### 1. Technical Field

The present disclosure generally relates to a device and a method to communicate with a user terminal, and more particularly, to a device and a method to share an image received from a user terminal with other user terminals.

### 2. Related Art

With the development of digital imaging devices, such as digital cameras and camcorders, many people can easily take desired photos or moving images. Further, with the development of the Internet, it is possible to upload a taken image to a web server and to share the uploaded image with other people.

A user may desire not to make the uploaded image public, or may desire to share the uploaded image with some limited people and to make the uploaded image private to the other people. In consideration of such requirements, a web server may provide various sharing types, such as making the image private and making the image public only with respect to people of a specific group, and may make the uploaded image public in accordance with the public type selected by the user.

However, even if the web server provides the various sharing types, it is necessary for a user to select the sharing type for each image to cause inconvenience in use. Further, since a user terminal should continuously access a web server in order to select the public type for each image, resources for this operation are consumed in the user terminal, web server, and network system including them.

The above-described contents are only to help understanding of a background technology of technical subject matters of the present disclosure, and thus they should not be understood as the contents corresponding to the related art known to those skilled in the art to which the present disclosure pertains.

### SUMMARY

Various embodiments of the present disclosure are directed to provide a device and a method capable of efficiently sharing an image received from a user terminal with other user identifications (IDs). For example, the device and the method according to certain embodiments of the present disclosure can efficiently configure access authorities of other user IDs for respective images.

In one aspect of the present disclosure, an image sharing server for sharing an image received from a user terminal, may include a communicator; and an image sharing device configured to communicate with the user terminal through the communicator, wherein the image sharing device is configured to generate a shared database by receiving mapping information between pieces of first identification data related to a plurality of characters and first client user IDs from the user terminal accessing through a main user ID, to acquire pieces of second identification data related to characters of a first image provided from the user terminal, and to select a client user ID being mapped to all of the pieces of second identification data among the first client user IDs with reference to the mapping information and to permit the selected client user ID to access the first image.

The image sharing server may further include a storage medium, and the image sharing device may be configured to store the shared database in the storage medium.

The image sharing device may be configured to communicate with an external storage medium through the communicator, and to store the shared database in the storage medium.

The image sharing device may be configured to acquire the pieces of the first identification data by performing face recognition with respect to second images received from the user terminal, and to acquire the pieces of the second identification data by performing the face recognition with respect to the first image.

The image sharing device may be configured to transmit a request signal including the pieces of the first identification data and the first client user IDs to the user terminal, and the mapping information may be provided as a feedback signal to the request signal.

The image sharing device may be configured to generate a relational database by identifying degrees of association between the pieces of the first identification data, and the pieces of the first identification data may include pieces of third and fourth identification data.

The image sharing device may be configured to transmit, to the user terminal, a message inquiring whether to map second client user IDs to the pieces of the fourth identification data in accordance with degrees of association between the pieces of the third and fourth identification data among the degrees of association in the case where the second client user IDs among the first client user IDs are mapped to the pieces of the third identification data.

The image sharing device may be configured to update mapping information between the pieces of the fourth identification data and the second clients into the shared database in response to a feedback signal to the message.

In another aspect of the present disclosure, a method for sharing an image received from a user terminal, may include receiving mapping information between pieces of first identification data related to a plurality of characters and first client user IDs from a user terminal accessing through a main user ID; receiving a first image from the user terminal; acquiring pieces of second identification data related to characters of the first image; selecting a client user ID being mapped to all of the pieces of the second identification data among the first client user IDs with reference to the mapping information; and permitting the selected client user ID to access the first image.

The permitting the access to the first image may include transmitting the first image to another user terminal accessing through the selected client user ID.

The method may further include receiving second images from the user terminal; and acquiring the pieces of the first identification data by performing face recognition with respect to the second images.

The method may further include transmitting a request signal including the acquired pieces of the first identification data and the first client user IDs to the user terminal, wherein the mapping information is provided as a feedback signal to the request signal.

The acquiring the pieces of the second identification data may include acquiring the pieces of the second identification data by performing the face recognition with respect to the first image.

The method may further include identifying degrees of association between the pieces of the first identification data, the pieces of the first identification data including pieces of third and fourth identification data; and transmitting, to the user terminal, a message inquiring whether to map second client user IDs to the pieces of the fourth identification data in accordance with degrees of association between the pieces of the third and fourth identification data among the degrees of association in the case where the second client user IDs among the first client user IDs are mapped to the pieces of the third identification data.

The method may further include receiving mapping information between the pieces of the fourth identification data and the second client user IDs in response to a feedback signal to the message.

According to some embodiments of the present disclosure, a device and a method may be capable of efficiently sharing an image received from a user terminal with other user IDs. For example, the device and the method according to various embodiments of the present disclosure can efficiently configure access authorities of other user IDs for respective images.

### BRIEF DESCRIPTION OF THE DRAWINGS

FIG. 1 is a block diagram of a network system including an image sharing server according to an embodiment of the present disclosure.

FIG. 2 is a block diagram of an image sharing server according to an embodiment of the present disclosure.

FIG. 3 is a diagram showing one of images stored in an image sharing server according to an embodiment of the present disclosure.

FIG. 4 is a table conceptually showing pieces of identification data generated from images according to an embodiment of the present disclosure.

FIG. 5 is a conceptual diagram exemplarily illustrating mapping relations between pieces of identification data and client user IDs stored in a shared database of FIG. 2.

FIG. 6 is a flowchart illustrating a method for generating and updating a shared database according to an embodiment of the present disclosure.

FIG. 7 is a flowchart illustrating an image sharing method according to an embodiment of the present disclosure.

FIG. 8 is a block diagram of an image sharing device according to another embodiment of the present disclosure.

FIG. 9 is a flowchart illustrating a method for generating and updating a shared database according to another embodiment of the present disclosure.

FIG. 10 is a block diagram illustrating a computer device suitable to implement image sharing servers of FIGS. 2 and 8 according to an embodiment of the present disclosure.

### DETAILED DESCRIPTION

Hereinafter, preferred embodiments of the present disclosure will be described in detail with reference to the accompanying drawings. In the following description, it is to be noted that only portions that are necessary to understand the operations according to the present disclosure will be described, and description of other portions will be omitted in order not to obscure the subject matter of the present disclosure. Further, the present disclosure is not limited to the embodiments as described hereinafter, but may be embodied in different forms. However, the embodiments as described hereinafter are only for specific details provided to assist those of ordinary skill in the art to which the present disclosure pertains in a comprehensive understanding of the disclosure.

In the entire description, the term “connected to” that is used to designate a connection of one element to another element includes both a case that an element is “directly connected to” another element and a case that an element is “indirectly connected to” another element via still another element. Here, the terms used herein are to explain specific embodiments, but are not intended to limit the present disclosure. In the entire description, the term “includes” or “including” used to designate that a certain portion “includes” a certain component means that other components are not excluded, but may be further included unless specially described to the contrary. The terms “at least any one of X, Y, and Z” and “at least any one selected from a group consisting of X, Y, and Z” may be analyzed as one X, one Y, one Z, or a certain combination of two or more of X, Y, and Z (e.g., XYZ, XYY, YZ, or ZZ). Here, the term “and/or” includes one or more of all combinations of corresponding configurations.

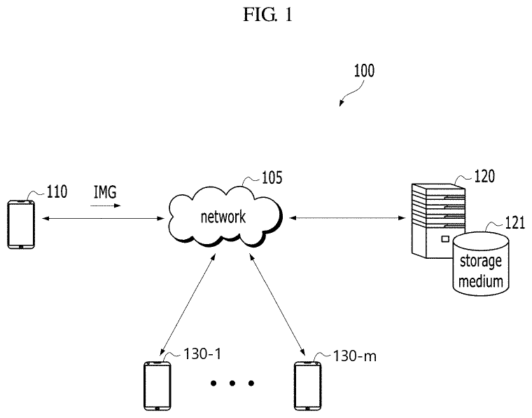

FIG. 1 is a block diagram of a network system including an image sharing server according to an embodiment of the present disclosure.

Referring to FIG. 1, a network system 100 may include a network 105, a plurality of user terminals 110 and 130-1 to 130-m, and an image sharing server 120.

The network system 100 may include a plurality of devices, servers, and/or software configurations, which operate to perform various methods according to embodiments of the present disclosure as described herein. The devices and/or servers illustrated in FIG. 1 may be configured in various or different types, and operations and services provided by the devices and/or the servers may be combined with or separated from each other for the embodiments described hereinafter, or may be performed by a larger or smaller number of devices and/or servers. One or more devices and/or servers may be driven and/or maintained by the same or different enterprises.

The network 105 connects various components in the network system 100, such as the user terminals 110 and 130-1 to 130-m and the image sharing server 120. The network 105 may include at least one of a public network, a private network, a wired network, a wireless network, other proper types of networks, and combinations thereof. Each of the user terminals 110 and 130-1 to 130-m and the image sharing server 120 may include or perform at least one of a wired communication function and a wireless communication function, and thus can communicate with each other through the network 105.

Each of the user terminals 110 and 130-1 to 130-m communicates with the image sharing server 120 through the network 105. Each of the user terminals may be registered with a user identification (ID) to the image sharing server 120, and thereafter, may access the image sharing server 120 through the user ID.

Each of the user terminals 110 and 130-1 to 130-m may upload one or more images into the image sharing server 120, and may receive one or more images uploaded by another user ID from the image sharing server 120.

For illustration purposes, in the present embodiment, it is assumed that the first user terminal 110 uploads one or more images IMG by accessing the image sharing server 120 through the corresponding user ID. In this case, the user ID uploading the images IMG may be defined as a “main user ID”. The images IMG uploaded by the main user ID as described above may be shared by or with other user IDs. The second user terminals 130-1 to 130-m may receive one, some or all of the images IMG by accessing the image sharing server 120 through their corresponding user IDs. In this case, the user IDs capable of sharing the uploaded images IMG may be defined as “client user IDs”. The main user ID can select the client user IDs among the user IDs. For example, the main user ID may register each of the client user IDs as “friend” by accessing the image sharing server 120 through the first user terminal 110.

The image sharing server 120 may perform operations related to image sharing services through communication with the user terminals 110 and 130-1 to 130-m over the network 105. A storage medium 121 may be configured to store the images IMG. In some embodiments, the storage medium 121 may be included in the image sharing server 120. In other embodiments, at least a part or whole of the storage medium 121 may be separated from the image sharing server 120, and the image sharing server 120 may communicate with the storage medium 121 through the network 105.

The image sharing server 120 may permit or deny accesses of the client user IDs for the respective stored images IMG in accordance with selection of the main user ID.

The image sharing server 120 may support the main user ID to configure (or select) mapping relations between pieces of identification data related to characters of the images IMG and the client user IDs. Thereafter, the image sharing server 120 may permit the client user ID mapped to all of the pieces of identification data of the respective images to access the corresponding images.

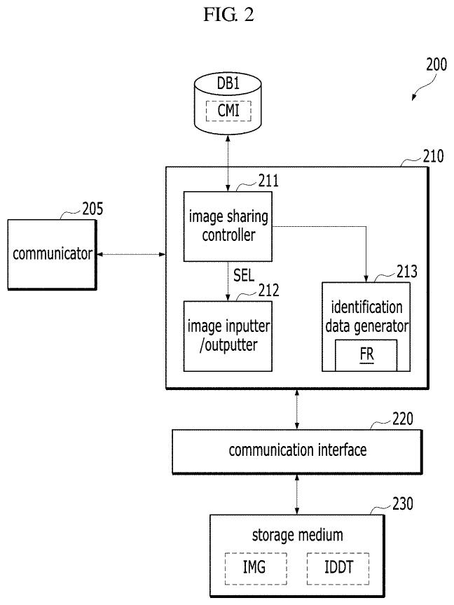

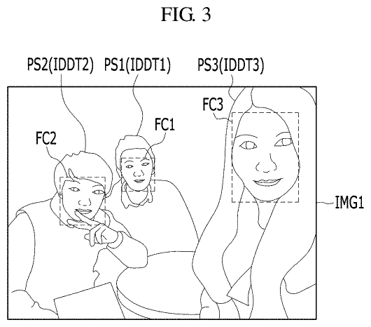

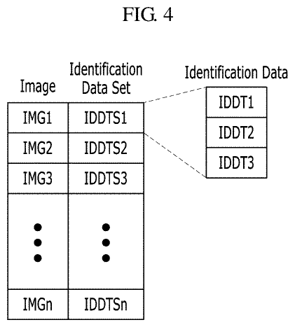

FIG. 2 is a block diagram of an image sharing server according to an embodiment of the present disclosure. FIG. 3 is a diagram showing an example of one of images stored in an image sharing server, and FIG. 4 is a table conceptually showing pieces of identification data generated from images.

Referring to FIG. 2, an image sharing server 200 may include a communicator 205, an image sharing device 210, a communication interface 220, a storage medium 230, and a shared database DB1.

The communicator 205 may communicate with the user terminals 110 and 130-1 to 130-m (refer to FIG. 1) through the network 105 (refer to FIG. 1). The communicator 205 may include or perform at least one of a wired communication function and a wireless communication function.

The image sharing device 210 may communicate with the user terminal 110 through the communicator 205. The image sharing device 210 may be connected to the storage medium 230 through the communication interface 220.

The image sharing device 210 may include an image sharing controller 211, an image inputter/outputter 212, and an identification data generator 213. The image sharing controller 211 may be configured to control the overall operation of the image sharing device 210 or one or more elements included in the image sharing device 210.

The image inputter/outputter 212 may operate in response to control signals from the image sharing device 210. The image inputter/outputter 212 is configured to receive the images IMG from the first user terminal 110 through the communicator 205, and to store the received images IMG in the storage medium 230 through the communication interface 220.

The image inputter/outputter 212 is configured to read the images IMG selected from the storage medium in accordance with a selection signal SEL and to transmit the read images IMG to a corresponding user terminal in the case where any one of the second user terminals 130-1 to 130-m accesses the image sharing server 200 through the client user ID. In this case, the selection signal SEL may specify the access-permitted images IMG to the corresponding client user ID. For example, the selection signal SEL may include addresses in which the images IMG selected from the storage medium 230 are stored.

The identification data generator 213 may operate in response to the control signals from the image sharing device 210. The identification data generator 213 is configured to read the respective images IMG from the storage medium 230 and to generate pieces of identification data IDDT from the read images IMG. Further, the identification data generator 213 is configured to store the generated pieces of identification data IDDT in the storage medium 230.

In embodiments, the identification data generator 213 may include a face recognizer FR. The face recognizer FR is configured to identify a face of a character included in an image. The same identification data is generated for the same character. Referring to FIG. 3 together with FIG. 2, the face recognizer FR is configured to process the first image IMG1 in a manner that it detects first to third characters PS1 to PS3 included in the first image IMG1, and identifies first to third faces of the first to third characters PS1 to PS3. Accordingly, pieces of first to third identification data IDDT1 to IDDT3 that are related to or correspond to the first to third characters PS1 to PS3 respectively are generated, and in this case, the first to third identification data IDDT1 to IDDT3 are different from each other through identification of the first to third faces FC1 to FC3 different from each other.

Then, referring to FIG. 4, identification data sets IDDTS1 to IDDTSn (where, n is an integer that is equal to or larger than 1) may be generated from the first to n-th images IMG1 to IMGn, respectively. Each of the identification data sets IDDTS1 to IDDTSn includes one or more pieces of identification data. For example, in the case where the first to third identification data IDDT1 to IDDT3 are extracted from the first image IMG1, the first identification data set IDDTS1 may include the first to third identification data IDDT1 to IDDT3.

As described above, the same identification data is generated for the same character, and the same character may be included in the plurality of images. Accordingly, the same identification data may be extracted from the plurality of images. That is, at least parts of the identification data set IDDTS1 to IDDTSn may include the same identification data.

Referring again to FIG. 2, the image sharing controller 211 may receive, from the first user terminal 110, mapping information CMI mapping between the pieces of identification data IDDT and the client user IDs. In embodiments, the image sharing controller 211 may transmit, to the user terminal 110, a request signal including at least parts of the pieces of identification data IDDT and at least parts of the registered client user IDs. The first user terminal 110 may transmit the mapping information CMI mapping between the pieces of identification data IDDT and the client user IDs to the image sharing server 200 as a feedback signal responded to the request signal of the image sharing controller 211. The image sharing controller 211 may update the received mapping information CMI into the shared database DB1.

In FIG. 2, the shared database DB1 is illustrated as a component separated from the storage medium 230. However, this is merely exemplary, and the technical subject matter of the present disclosure is not limited thereto. Alternatively, the shared database DB1 may be included in at least one of various storage media related to the image sharing server 200. As another example, the storage medium including the shared database DB1 may be located outside the image sharing server 200, and the image sharing server 200 may access the shared database DB1 through the communicator 205.

The image sharing controller 211 is configured to permit or deny accesses of the client user IDs for the respective images IMG with reference to the mapping information CMI. As described above with reference to FIG. 4, each image may correspond to one or more pieces of identification data. The image sharing controller 211 may select the client user ID mapped to all of the pieces of identification data corresponding to the image, and may permit the selected client user ID to access the corresponding image. The accesses of the remaining client user IDs to the corresponding image may be denied.

In the case where any one of the second user terminals 130-1 to 130-m accesses the image sharing server 200 through the client user ID, the image sharing controller 211 may output a selection signal SEL to select the access-permitted images of the corresponding client user ID among the images IMG stored in the storage medium 230. The image inputter/outputter 212 is configured to read the selected images in accordance with the selection signal SEL, and to transmit the read images to the corresponding user terminal.

The communication interface 220 provides a communication interface for connecting the storage medium 230 to the image sharing device 210. For example, components of a system bus included in the image sharing server 200 may be provided as the communication interface 220.

The storage medium 230 may function as the storage medium 121 of FIG. 1. The storage medium 230 may be configured to store the images IMG and the pieces of identification data IDDT. The storage medium 230 may be, for example, but not limited to, a nonvolatile storage device.

According to an embodiment of the present disclosure, after the main user ID sets which client user ID is to be mapped to the identification data corresponding to the character, access authority for another image and/or a newly added image may be determined without additional setting of the main user ID in the case where the corresponding image has predetermined identification data. The image sharing server 200 may select the client user ID mapped to all of the pieces of identification data corresponding to the image, and may permit the selected client user ID to access the corresponding image. Accordingly, resources of the network system 100, the network 105, and/or the user terminal 110, which are consumed to set the access authority for each image, may be reduced, and user convenience may also be improved.

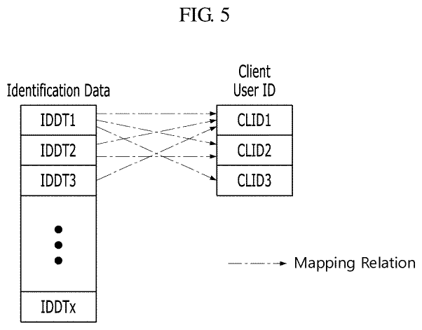

FIG. 5 is a conceptual diagram exemplarily illustrating mapping relations between pieces of identification data and client user IDs stored in a shared database of FIG. 2.

Referring to FIG. 5, mapping relations between pieces of identification data IDDT1 to IDDTx and client user IDs CLID1 to CLID3 are illustrated (where, x is an integer that is equal to or larger than 1). The first identification data IDDT1 is mapped to the first to third client user IDs CLID1 to CLID3, the second identification data IDDT2 is mapped to the first and second client user IDs CLID1 and CLID2, and the third identification data IDDT3 is mapped to the first client user ID CLID1.

On the other hand, as illustrated in FIG. 3, the pieces of the first to third identification data IDDT1 to IDDT3 may be extracted from the first image IMG1. In this case, the first client user ID CLID1 mapped to all of the first to third identification data IDDT1 to IDDT3 may be selected, and the selected first client user ID CLID1 may be permitted to access the corresponding image. The accesses of the second and third client user IDs CLID2 and CLID3 to the first image IMG1 may be denied.

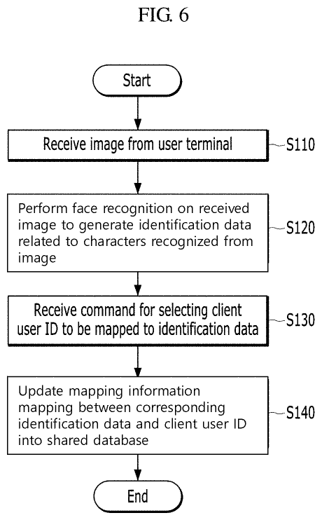

FIG. 6 is a flowchart illustrating an embodiment of a method for generating and updating a shared database.

Referring to FIGS. 1 and 6, at operation S110, an image is received from the first user terminal 110. At operation S120, face recognition is performed with respect to the received image, and identification data related or corresponding to a character recognized from the image is generated.

At operation S130, a command for selecting a client user ID to be mapped to the identification data is received from the first user terminal 110. For example, the image sharing server 120 may transmit, to the first user terminal 110, a request signal including the identification data and registered client user IDs, and the user terminal 110 may transmit, to the image sharing server 120, a command for selecting the client user ID to be mapped to the identification data among the registered client user IDs as a feedback signal responding to the request signal.

At operation S140, the mapping information mapping between the identification data and the client user IDs is updated into the shared database.

Operations S120 to S140 may be performed when the respective images are received from a user terminal. However, the technical subject matter of the present disclosure is not limited thereto. For example, the operation S120 may be performed when the respective images are received from a user terminal, and operations S130 and S140 may be performed with respect to the plurality of images. As another example, after the plurality of images are received from a user terminal, the operations S120 and S140 may be performed with respect to the images.

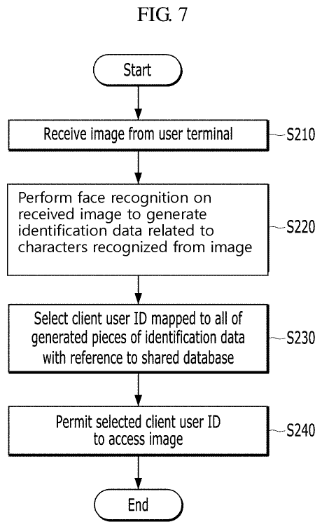

FIG. 7 is a flowchart illustrating an image sharing method according to an embodiment of the present disclosure.

Referring to FIGS. 1 and 7, at operation S210, an image is received from the user terminal 110. At operation S220, face recognition is performed with respect to the received image, and pieces of identification data related to respective characters recognized from the image are generated.

At operation S230, client user IDs to be mapped to all of the generated pieces of identification data are selected with reference to the mapping information stored in the shared database. At operation S240, the selected client user ID is permitted to access the corresponding image. For example, the image sharing server 120 may provide the user terminal accessing through the selected client user ID with the permitted image and/or information related to the permitted image.

According to an embodiment of the present disclosure, after the main user ID sets which client user ID is to be mapped to the identification data corresponding to the character, access authority for another image and/or a newly added image may be determined without additional setting of the main user ID in the case where the corresponding image has predetermined identification data. Accordingly, resources of the network system 100, the network 105, and/or the user terminal 110, which are consumed to set the access authority for each image, may be reduced, and user convenience may also be improved.

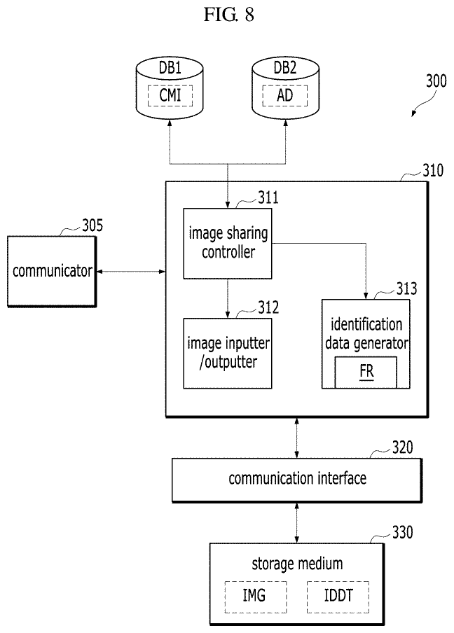

FIG. 8 is a block diagram of an image sharing device according to another embodiment of the present disclosure.

Referring to FIG. 8, an image sharing server 300 includes a communicator 305, an image sharing device 310, a communication interface 320, a storage medium 330, a shared database DB1, and a relational database DB2.

The image sharing device 310 includes an image sharing controller 311, an image inputter/outputter 312, and an identification data generator 313. The image inputter/outputter 312 and the identification data generator 313 are configured in the same or similar manner as or to the image inputter/outputter 212 and the identification data generator 213 described above with reference to FIG. 2. Hereinafter, the duplicate description thereof will be omitted.

As described above with reference to FIG. 2, the image sharing controller 311 may generate and/or update the shared database DB1 including the mapping information CMI. The image sharing controller 311 may permit or deny accesses of the client user IDs for the respective images IMG with reference to the mapping information CMI. Further, the image sharing controller 311 is configured to generate and/or update the relational database DB2 by identifying the degrees of association AD between the pieces of identification data IDDT.

In FIG. 8, the relational database DB2 is illustrated as a component separated from the storage medium 330. However, this is merely exemplary, and the technical subject matter of the present disclosure is not limited thereto. The relational database DB2 may be at least one of various storage media related to the image sharing server 300. For example, the relational database DB2 may be included in the storage medium 330. As another example, a storage medium including the relational database DB2 may be located outside the image sharing server 300, and the image sharing server 300 may access the relational database DB2 through the communicator 305.

The degrees of association AD between pieces of identification data IDDT may be determined in accordance with various methods. For example, if first to third identification data corresponding to first to third characters are repeatedly extracted from a plurality of images IMG, the first to third identification data may have relatively high degrees of association. If third and fourth identification data corresponding to third and fourth characters are repeatedly extracted from the plurality of images IMG, but the pieces of the first, second, and fourth identification data are not extracted from any image, the third and fourth identification data may have relatively high degrees of association, but the first and second identification data may have relatively low degrees of association as compared with the fourth identification data. As described above, the degrees of association AD may be determined in accordance with various factors, such as the number of times of identification data extraction, and the number of images having the same identification data. The respective degrees of association may be quantified to values. As the number of images IMG becomes larger, the degrees of association AD may have higher reliability in statistics.

The image sharing controller 311 may transmit, to the first user terminal 110 (refer to FIG. 1), a recommendation message inquiring whether to map a client user ID to other identification data having a higher degree of association in the case where the client user ID is mapped to specific identification data. For example, in the case where the client user ID is mapped to the first identification data, and the first identification data and the second identification data have the degrees of association higher than a critical or predetermined value, the image sharing controller 311 may transmit, to the first user terminal 110, a recommendation message inquiring whether to map the client user ID to the second identification data.

The image sharing controller 311 may receive, from the first user terminal 110, a command for accepting the mapping between the identification data included in the recommendation message and the client user ID as a feedback signal responding to the recommendation message. The image sharing controller 311 may update the received mapping information into the mapping information CMI of the shared database DB1.

According to an embodiment of the present disclosure, the image sharing server 300 identifies or calculates the degrees of association AD between the pieces of the identification data IDDT, and provides the recommendation message inquiring whether to map the identification data to the client user ID based on the degrees of association AD. In accordance with the acceptance of the main user ID, the mapping information CMI of the shared database DB1 may be updated. Accordingly, the image sharing server 300 may provide high convenience in the case where the main user ID sets the access authority for each client user ID.

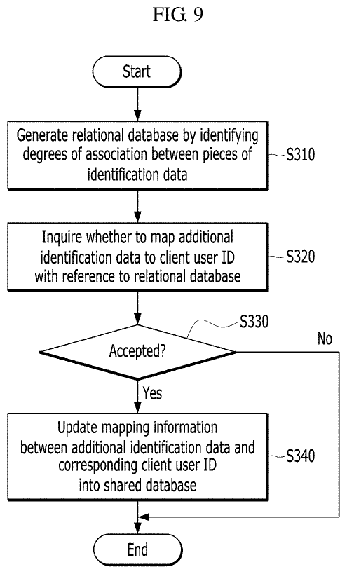

FIG. 9 is a flowchart illustrating a method for generating and updating a shared database according to another embodiment of the present disclosure.

Referring to FIGS. 8 and 9, at operation S310, the degrees of association AD between pieces of identification data IDDT are identified or calculated, and a relational database DB2 is generated and/or updated based on the identified or calculated degrees of association AD. At operation S320, with reference to the degrees of association AD of the relational database DB2, a recommendation message inquiring whether to map additional identification data to a client user ID is transmitted to the first user terminal 110. For example, the image sharing server 300 may inquire whether to map the second identification data having the degree of association higher than a critical or predetermined value with respect to the first identification data to the client user ID mapped to the first identification data.

When the main user ID accepts the mapping between the additional identification data and the client user ID at operation S330, operation S340 may be performed. The main user ID may transmit a message for accepting mapping between the additional identification data and the client user ID through the first user terminal 110 as a feedback signal responding to the recommendation message.

At operation S340, the mapping information mapping between the additional identification data and the client user ID may be added to the mapping information CMI of the shared database DB1.

The method according to an embodiment of the present disclosure may provide, to the main user ID, the recommendation message inquiring whether to map the identification data to the client user ID in accordance with the degrees of association AD between the pieces of the identification data IDDT. Accordingly, it is possible to provide high convenience in the case where the main user ID sets the access authority for each client user ID.

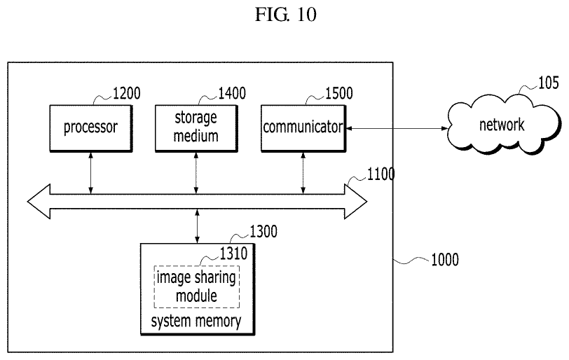

FIG. 10 is a block diagram illustrating an embodiment of a computer device suitable to implement an image sharing server of FIGS. 2 and 8.

Referring to FIG. 10, a computer device 1000 includes a bus 1100, at least one processor 1200, a system memory 1300, a storage medium 1400, and a communicator 1500.

The bus 1100 is connected to various components of the computer device 1000 to transfer data, signals, and information. The processor 1200 may be any one of a general purpose processor and a dedicated processor, and may control the overall operations of the computer device 1000. At least parts of components of the bus 1100 may function as the communication interfaces 220 and 320 of FIGS. 2 and 8.

When executed, the processor 1200 is configured to load program codes and instructions for providing various functions into the system memory 1300, and to process the loaded program codes and instructions. For example, the system memory 1300 may be provided as a working memory of the processor 1200.

As an embodiment, the system memory 1300 may include at least one of a random access memory (RAM), a read only memory (ROM), and media readable by other-type computers.

The processor 1200 may load an image sharing module 1310 providing functions or capabilities of the image sharing devices 210 and 310 of FIGS. 2 and 8 when executed by the processor 1200 into the system memory 1300. Such program codes and/or instructions may be executed by the processor 1200 to function as the image sharing devices 210 and 310 as described above with reference to FIGS. 2 and 8. For example, the image sharing module 1310, when executed by the processor 1200, may perform functions or operations of the image sharing controllers 211 and 311, the image inputters/outputters 212 and 312, and the identification data generators 213 and 313 as illustrated in FIGS. 2 and 8. In addition, the system memory 1300 may further include program codes and instructions providing one or more additional functions when executed by the processor 1200.

The program codes and/or the instructions to be loaded into the system memory 1300 may be loaded from the storage medium 1400 that is a separate computer-readable recording medium. The program codes and the instructions may be loaded from an external device into the system memory 1300 through the communicator 1500. Further, the storage medium 1400 may function as the storage media 230 and 330 of FIGS. 2 and 8 and/or the databases DB1 and DB2 of FIGS. 2 and 8.

As an embodiment, the storage medium 1400 may include various types of nonvolatile storage media to maintain the stored data even if a power supply is blocked, for example, a flash memory and a hard disk.

The communicator (or transceiver) 1500 transmits and receives signals between the computer device 1000 and other devices in the network system 100 (refer to FIG. 1) through the network 105. The communicator 1500 may function as the communicators 205 and 305 of FIGS. 2 and 8.

Although specific embodiments and application examples have been described herein, they are merely to help comprehensive understanding of the present disclosure, but the present disclosure is not limited to the above-described embodiments. Various corrections and modifications are possible from the description by those of ordinary skill in the art to which the present disclosure pertains.

Accordingly, the subject matter of the present disclosure should not be limited based on the described embodiments, and it may be construed that not only claims to be described later but also all equal or equivalent modifications of the claims belong to the scope of the present disclosure.

What is claimed is:

1. A server for sharing an image received from a user terminal, comprising:
a communicator; and
an image sharing device configured to communicate with the user terminal through the communicator,
wherein the image sharing device is configured:
to generate a shared database by receiving mapping information mapping between pieces of first identification data corresponding to a plurality of characters and first client user identifications (IDs) from the user terminal accessing through a main user ID,
to acquire pieces of second identification data corresponding to characters of a first image provided from the user terminal, and
to select a client user ID being mapped to all of the pieces of second identification data among the first client user IDs with reference to the mapping information, and to permit the selected client user ID to access the first image.

2. The server of claim 1, further comprising a storage medium,
wherein the image sharing device is configured to store the shared database in the storage medium.

3. The server of claim 1, wherein the image sharing device is configured to communicate with an external storage medium through the communicator, and to store the shared database in the external storage medium.

4. The server of claim 1, wherein the image sharing device is configured:
to acquire the pieces of the first identification data by performing face recognition on second images received from the user terminal, and
to acquire the pieces of the second identification data by performing the face recognition on the first image.

5. The server of claim 4, wherein the image sharing device is configured:
to transmit a request signal including the pieces of the first identification data and the first client user IDs to the user terminal, and
to receive, from the user terminal, a feedback signal responding to the request signal, the feedback signal including the mapping information.

6. The server of claim 1, wherein the image sharing device is configured to generate a relational database by identifying degrees of association between the pieces of the first identification data.

7. The server of claim 6, wherein:
the pieces of the first identification data include pieces of third and fourth identification data, and
the image sharing device is configured to transmit, to the user terminal, a message inquiring whether to map second client user IDs to the pieces of the fourth identification data in accordance with degrees of association between the pieces of the third and fourth identification data among the degrees of association between the pieces of the first identification data in the case where the second client user IDs among the first client user IDs are mapped to the pieces of the third identification data.

8. The server of claim 7, wherein the image sharing device is configured to update mapping information mapping between the pieces of the fourth identification data and the second client user IDs into the shared database in response to a feedback signal responding to the message.

9. A method for sharing an image received from a user terminal, comprising:
receiving, from a user terminal accessing through a main user identification (ID), mapping information mapping between pieces of first identification data corresponding to a plurality of characters and first client user IDs;
receiving a first image from the user terminal;
acquiring pieces of second identification data corresponding to characters included in the first image;
selecting a client user ID being mapped to all of the pieces of the second identification data among the first client user IDs with reference to the mapping information; and
permitting the selected client user ID to access the first image.

10. The method of claim 9, wherein the permitting the selected client user ID to access the first image comprises transmitting the first image to one or more other user terminals accessing through the selected client user ID.

11. The method of claim 9, further comprising:
receiving second images from the user terminal; and
acquiring the pieces of the first identification data by performing face recognition on the second images.

12. The method of claim 11, further comprising:
transmitting a request signal including the acquired pieces of the first identification data and the first client user IDs to the user terminal,
receiving, from the user terminal, a feedback signal responding to the request signal, the feedback signal including the mapping information.

13. The method of claim 11, wherein the acquiring the pieces of the second identification data comprises acquiring the pieces of the second identification data by performing the face recognition on the first image.

14. The method of claim 9, further comprising:
identifying degrees of association between the pieces of the first identification data, the pieces of the first identification data including pieces of third and fourth identification data; and
transmitting, to the user terminal, a message inquiring whether to map second client user IDs to the pieces of the fourth identification data in accordance with degrees of association between the pieces of the third and fourth identification data among the degrees of association between the pieces of the first identification data in the case where the second client user IDs among the first client user IDs are mapped to the pieces of the third identification data.

15. The method of claim 14, further comprising receiving mapping information mapping between the pieces of the fourth identification data and the second client user IDs in response to a feedback signal responding to the message.
